(19) United States
(12) Patent Application Publication
(10) Pub. No.: US 2009/0204506 A1
(43) Pub. Date: Aug. 13, 2009

(54) E-COMMERCE SYSTEM AND METHOD

(76) Inventors: Haruo Yoshida, Gyoda-shi (JP); Mitsuru Tanaka, Tsukuba-shi (JP)

Correspondence Address: OSTROLENK FABER GERB & SOFFEN, 1180 AVENUE OF THE AMERICAS, NEW YORK, NY, 100368403, US

(21) Appl. No.: 12/299,528

(22) PCT Filed: Feb. 8, 2007
(86) PCT No.: PCT/JP2007/052280

§ 371 Date: Nov. 4, 2008

(30) Foreign Application Priority Data
May 10, 2006 (JP) 2006-131589

(51) Int. Cl. G06Q 30/00

(52) U.S. Cl. 705/26

(57) ABSTRACT

The present invention provides a subsystem that guarantees quality, safety, or environmental performance of the commodities. The subsystem is provided with a database that stores numerical characteristics that characterize regulations, standards, or required specifications regarding the quality, safety, or environmental performance of the commodities in the e-commerce transaction, and the database can be viewed from both the buyer and seller. To the buyer, the seller delivers the commodity, the quality, safety, or environmental performance of which are guaranteed regarding the numerical characteristics that characterize the regulations, standards, or required specifications. The buyer, when carrying out inspection on the delivered commodity to see whether or not the regulations, standards, or required specifications are met to determine whether to accept or reject the commodity, guarantees the correctness of measurement values for determining acceptance/rejection upon the numerical characteristics that characterize the regulations, standards, or required specifications.

### TECHNICAL FIELD

The present invention relates to an e-commerce system and method whereby a buyer buys commodities sold by a seller through an e-commerce market place.

### BACKGROUND ART

In general, the quality of commodities cannot be determined only by standards. It is not possible unless there is a total quality management system that encompasses levels of manufactures' manufacturing technique (craftsmanship) and technical know-how. The Japan-style quality management system “affiliate” realized such a system. However, the maintenance costs of the “affiliate” are high and therefore the cost of commodity manufacturing cannot be reduced. Due to this disadvantage, acceleration of deflation and cost-reduction pressure caused the “affiliate” to collapse after the bubble economy burst in the 1980s, and e-commerce, which is favorable for achieving cost reduction, is now being actively pursued.

According to “FY 2004 research on actual situation and market size of e-commerce” published by the Japan Ministry of Economy, Trade and Industry in June 2005, among those e-commerce transactions that took place in Japan in FY 2004, B to B (business to business) e-commerce transactions that used internet technologies accounted for approximately 103 trillion yen with a 33% increase from the previous financial year (FIG. 10 shows an example of a B to B (business to business) e-commerce transaction model. B to C (business to consumer) e-commerce transactions accounted for 5.6 trillion yen with a 28% increase. The break down of the FY 2004 B to B internet purchasing market is as follows: automobiles 33.4%; electronics/information related equipment 24%; ferrous/non-ferrous/materials 6.4%; insurance services 5.8%; industrial precision equipment 7.2%; and others 19.1%, and internet purchases, the major areas of which were previously automobiles and electronics/information related equipment, seem to have extended across industry-wide areas. Moreover, a shift from conventional e-commerce VAN services to internet (IP) based purchases has been emerging (refer to FIG. 11, FIG. 12. “e-market place” in FIG. 12 refers to a place for e-commerce transactions).

E-commerce transactions are utilized in the automobile industry. As a measure for reducing the component purchase cost, which is said to account for 60 to 70% of the total automobile production cost, “global purchases (departing from so called “affiliate”, and making material purchases from any business organization in the world as long as transaction conditions are satisfied)” have been carried out, and e-commerce transactions are frequently used as measures therefor. From a finished-car manufacturer's point of view, there are two advantages in this. The first advantage of this is that as long as the quality, price, and delivery time of components meet those required by the finished car manufacturer, it is possible to purchase the most inexpensive components as a result of competition of suppliers around the world, resulting in a reduction in the cost. The second advantage is that a finished car manufacturer having production bases all around the world can make purchases all at once from a supplier company that is capable of providing world wide supply, while it is possible, with an advantage of scale, to reduce cost and time required for development and manufacturing. In FY 2004, the total domestic car production in Japan was 10.51 million units, and the total overseas production was 9.79 million units (according to investigations carried out by the Japan automobile manufacturers association), suggesting that overseas production is increasingly becoming important for finished car manufacturers. Recent partnerships between Japanese car companies and foreign manufacturers have also promoted the shift towards global purchasing. Along with the popularization of the Internet, some changes have been observed in business-to-business transactions and new internet purchasing has been carried out. Covisint (comprehensive e-commerce transaction market place for automobile components and materials operated by Covisint and established in December 2000 as a consortium of five major automobile companies of Japan, the United States of America, and Europe, including American top three companies; a user proposes specifications and quantities of required components on the internet, and prices are determined upon tendering) may be taken as an example of automobile related internet purchasing. Japan's JNX (Japanese automotive network exchange) is an example of a closed industrial network on dedicated lines, which is a network in-between dedicated line and internet purchasing. An advantage of this for a finished car manufacturer is that all companies registered to the network can be contacted easily and a wider range of component purchasing selection is offered, and as a result, quality and price become more competitive than ever between supplier companies.

Such an internet purchasing movement for reducing production material purchasing cost is seen not only in the automobile industry and it is also expanding across many industries including food, electronic components, steel, electric power facilities, and public services. This climate will soon pass the point of no return. FIG. 13 shows the processes of a generic e-commerce transaction. Non Patent Document 1 shows a list of companies and government offices that currently (2006) use domestic internet purchasing in Japan. As described above with an overview, the advantage of e-commerce transactions includes a cost reduction in production material purchasing (reduction in product cost), reduced lead time, reduction in product/component stock, and reduction in development time.

However, there are risks in carrying out e-commerce transactions such as:
risks in the quality and safety of products (including quality and safety of products, and quality assurance system);
environmental risks (including management of chemical substances contained in the product, management of chemical substances used in the manufacturing process, impact on the environment (such as discharged water and discharged gas), environmental administration approval, waste products, and greenhouse gas emissions);
risks in information security (including threat to computer network [such as exposure of data or servers on network to unauthorized persons, and illegal alteration or destruction of data or servers on network], leaking of personal information, and leaking of customer/third party information); and
risks concerning fair trade (including abuse of dominant position, inappropriate profit sharing, and information disclosure).

Key issues here are how these risks are to be managed. Heretofore, risks in information security have been pointed out and addressed as risks regarding e-commerce transactions. However, sufficient measures for managing risks in the quality, safety, and environmental performance of transaction target commodities have not been put in place.

[Non Patent Document 1] http://www.pluscome.com/chotatu.htm

### DISCLOSURE OF INVENTION

### Problems to be Solved by the Invention

An object of the present invention is to manage and reduce, among the above mentioned risks associated with e-commerce transactions, risks regarding the quality, safety, or environmental performance of the commodities regarding the e-commerce transactions.

The present invention aims to guarantee quality, safety or environmental performance when carrying out e-commerce transactions between any places in the world, by organically combining the laboratory accreditation international standard ISO/IEC17025 on the initiative of ILAC (international laboratory accreditation cooperation), with Global MRA (mutual recognition agreement), which has recently been developed at the initiative of the bureau international des poids et measures (BIPM), for guaranteeing the correctness of measurement values on measuring devices that determine whether or not numerical characteristics of various kinds of standards (such as international quality standard ISO9001, international environmental standard ISO14001, information security standard ISO/IEC17799, food standard ISO9001+HACCP, electromagnetic environmental compatibility test EMC approval, environmental RoHS directive, international standards such as overseas safety accreditation test CE marking, Japanese industrial standards JIS, and automobile safety standards of other countries) on quality, safety or environmental performance that characterize these standards, are met. Furthermore, in the case where any standard is not met (rejected), an analysis for identifying the location of the problem is possible, and a mechanism for quickly addressing problems is achieved. Moreover, the mechanism also enables cost-balance analysis (whether or not acceptance is made when at an excessive level of quality) in the case of acceptance.

### Means for Solving the Problems

The e-commerce system and method of the present invention relates to an e-commerce system and method whereby a buyer buys commodities sold by a seller through an e-commerce market place. There is embedded a subsystem that guarantees quality, safety, or environmental performance, wherein the subsystem is provided with a database that stores numerical characteristics that characterize regulations, standards, or required specifications regarding the quality, safety, or environmental performance of the commodity to be traded in the e-commerce transaction, and the database can be viewed from both the buyer and seller. To the buyer, the seller delivers the commodity, the quality, safety, or environmental performance of which are guaranteed regarding the numerical characteristics that characterize the regulations, standards, or required specifications. The buyer, when carrying out inspection on the delivered commodity to see whether or not the regulations, standards, or required specifications are met to determine whether to accept or reject the commodity, guarantees correctness of measurement values for determining acceptance/rejection upon the numerical characteristics that characterize the regulations, standards, or required specifications.

Moreover, the present invention is characterized in that in order for the seller to guarantee quality, safety, or environmental performance of commodities (products, half-completed products [modules], and components) on e-commerce market places (including not only entirely open internet market places but also industry specific closed network market places), the seller, regarding the numerical characteristics that characterize regulations (such as laws and RoHs directive), standards (such as international standards, Japanese industrial standards, and automobile safety standards) and required specifications concerning the commodities to be traded, is to disclose: measurement results of respective items for certifying those standards; traceability (traceability to national measurement standard) for certifying correctness of the measurement results; reliability evaluation method; and reliability level thereof. It is operated as a subsystem of a conventional e-commerce system.

Moreover, the present invention is such that in an e-commerce market place, the buyer discloses regulations, standards, and required specifications regarding the quality, safety, or environmental performance of a commodity that the buyer wishes to buy, and regarding numerical characteristics that characterize these regulations, standards, and required specifications, the buyer requests the seller, at the time of tendering or delivering, to disclose; measurement results for certifying that these regulations, standards, and required specifications are met, traceability for certifying the correctness of the measurement results, the reliability evaluation method, and the reliability level thereof.

Moreover, the present invention is such that the buyer and seller discuss regulations, standards, and required specifications that concern the quality, safety, or environmental performance that need to be met for the target commodity of the e-commerce transaction, and reach an agreement on which one of them is to be employed and operated. The buyer, at the time of commencing the transaction or in the middle of the transaction, inspects the delivered commodities to determine whether or not the numerical characteristics of the regulations, standards, and required specifications are met (if the quantity is large, a sampling inspection is carried out) to determine whether to accept or reject (if the quantity is large, a reliability determination is carried out based on a statistical method), and either continues or cancels the transaction (or changes the transaction conditions). The buyer is responsible to guarantee the correctness of the measurement values for determining whether to accept or reject each of these items (measuring device management, measurement standard traceability [traceability], description of the reliability evaluation method used to calculate the reliability level, and so forth).

Furthermore, the present invention is such that regarding the delivered commodities, the buyer carries out an inspection to see whether or not the reliability level of the numerical characteristics that characterize these respective items disclosed by the seller, and the reliability level required by the buyer are met, to determine whether to accept or reject.

Moreover, the present invention is such that the regulations, standards, required specifications and so forth regarding the quality, safety, or environmental performance that the target commodity of the e-commerce transaction needs to meet are broken down into component requirements, and the buyer carries out inspection on respective items to determine acceptance or rejection. The buyer is responsible for guaranteeing the correctness of measurement values that determine acceptance or rejection of the respective items.

Furthermore, the present invention is such that the target commodity for the e-commerce transaction is disassembled into component parts (or module components), and the buyer carries out inspection on each item of the regulations, standards, and required specifications regarding the quality, safety or environmental performance that these component parts need to meet, to determine whether to accept or reject the commodity. The buyer is responsible for guaranteeing the correctness of measurement values that determine acceptance or rejection of the respective items.

Moreover, the present invention is such that an inspection certificate of all of the regulations, standards, and specifications is to be sent as an electronic file from the buyer to the seller. This inspection certificate shows not only the comprehensive determination results but also the individual determination results of each of the requirements that form the regulations, standards, specifications and so forth regarding the commodity.

Moreover, the present invention is such that in the case where an item is rejected and the seller has a doubt about the determination result, if a reference item is invoked, it can be linked to detailed rejection information (whether or not the version of the regulations and so forth is appropriate; the measurement results; the management status of the measuring device; the calibration history of the measuring device; the measurement standard traceability; the reliability evaluation method and the statistical processing method used to calculate reliability level; and so forth). It becomes possible for the seller to analyze problems and to thereby quickly acquire a way of making improvement. Furthermore, if an item is rejected, how it is distributed with respect to the target numerical characteristic is analyzed, and it is reported to the person who requested measurement whether or not the acceptance and cost are balanced (even if accepted, whether or not it is distributed in the proximity of the target value and an excessive quality has caused cost overrun).

Moreover, the present invention is such that in order to quickly collect required information from a large volume of information, there are provided: an agent function that appropriately selects the regulations, the standards, the required specifications and so forth regarding the quality, safety, or environmental performance that need to be met for the target commodity for the buyer and seller in an e-commerce transaction; an agent function that appropriately selects the measuring device management, the measurement standard traceability (traceability), the reliability evaluation method used to calculate the reliability level, and so forth for guaranteeing the measurement results that need to be shown in the inspection by the buyer; and an agent function that summarizes the detailed contents of the item rejected as a result of the inspection. An inspection for determining whether to accept or reject can be entrusted to an agent function that is competent and equitable.

Moreover, the measurement standard traceability (traceability) for guaranteeing measurement results required to be shown by the buyer in the inspection, is based on the measurement standard supply program in which a national measurement standard organization participates in CIPM-MRA (international committee for weights and measures—mutual recognition arrangement) for ensuring constant quality even in international e-commerce transactions.

Furthermore, the measurement standard supply organization that guarantees measurement results required to be shown by the buyer in the inspection, is an organization approved based on the international laboratory accreditation standard (ISO/IEC17025) for ensuring the quality of the measurement standard supply.

Moreover, the standard supply of the measurement standard for guaranteeing measurement results that need to be shown by the buyer in the inspection is based on an appropriate measurement standard supply system (for example, JCSS [Japan calibration service system] and ASNITE-CAL).

Furthermore, methods of the measurement standard supply include: carry-in calibration (calibration equipment are carried in to an upper calibration organization to carry out calibration); visit-calibration (a staff member of the upper calibration organization visits the site where there are calibration equipment that cannot be easily transported, to carry out calibration); or remote calibration (with use of communication technologies, without a staff member having to visit the site and without having to transport the calibration equipment, calibration is carried out on site at the responsibility of the calibration organization).

### EFFECT OF THE INVENTION

Heretofore, risks in information security have been mainly pointed out and addressed as risks regarding e-commerce transactions. However, sufficient measures for managing risks in the quality, safety, and environmental performance of transaction target commodities have not been put in place. According to the present invention, it is possible to manage and reduce, among the risks associated with e-commerce transactions (risks in quality/safety of product, environmental risks, information security risks, and risks related to fair trade), risks related to the quality, safety, or environmental performance of the commodities.

Moreover, according to the present invention, by operating as a subsystem of a conventional e-commerce system, risks related to the quality, safety, or environmental performance of commodities of e-commerce transactions are expected to decrease significantly.

The inspection certificate sent from the buyer to the seller shows not only comprehensive determination results but also an individual determination result of each of the requirements that form the regulations, standards, and specifications regarding the commodities, and in the case of rejection, problems become clear as the detailed reasons of the rejection can be linked if required, and it is possible for the seller to thereby quickly acquire a way of making improvements.

### BRIEF DESCRIPTION OF THE DRAWINGS

FIG. 1 is a diagram showing an example of e-commerce transactions, in which there is embedded a subsystem for guaranteeing the quality, safety, or environmental performance of commodities.

FIG. 2 is a diagram showing an example of a subsystem of e-commerce transactions for guaranteeing quality, safety, or environmental performance.

FIG. 3 is a diagram showing detailed analysis of acceptance/rejection shown in FIG. 2.

FIG. 4 is a diagram showing an example of a developed type of a subsystem provided with an agent function for information acquisition.

FIG. 5 is a diagram showing an example of a hierarchical system of standards in the subsystem of e-commerce transactions for guaranteeing quality, safety, or environmental performance.

FIG. 6 is a diagram showing an example of a commodity hierarchical system in the subsystem of e-commerce transactions for guaranteeing quality, safety, or environmental performance.

FIG. 7 is a diagram showing an example of a measurement standard supply traceability system.

FIG. 8 is a diagram for describing a measurement standard supply system and a supply method.

FIG. 9 is a diagram for describing remote proofing.

FIG. 10 is a diagram showing an example of a B to B (business to business) e-commerce model.

FIG. 11 is a table showing comparisons between an e-market place, EDI (electronic data interchange), and the like.

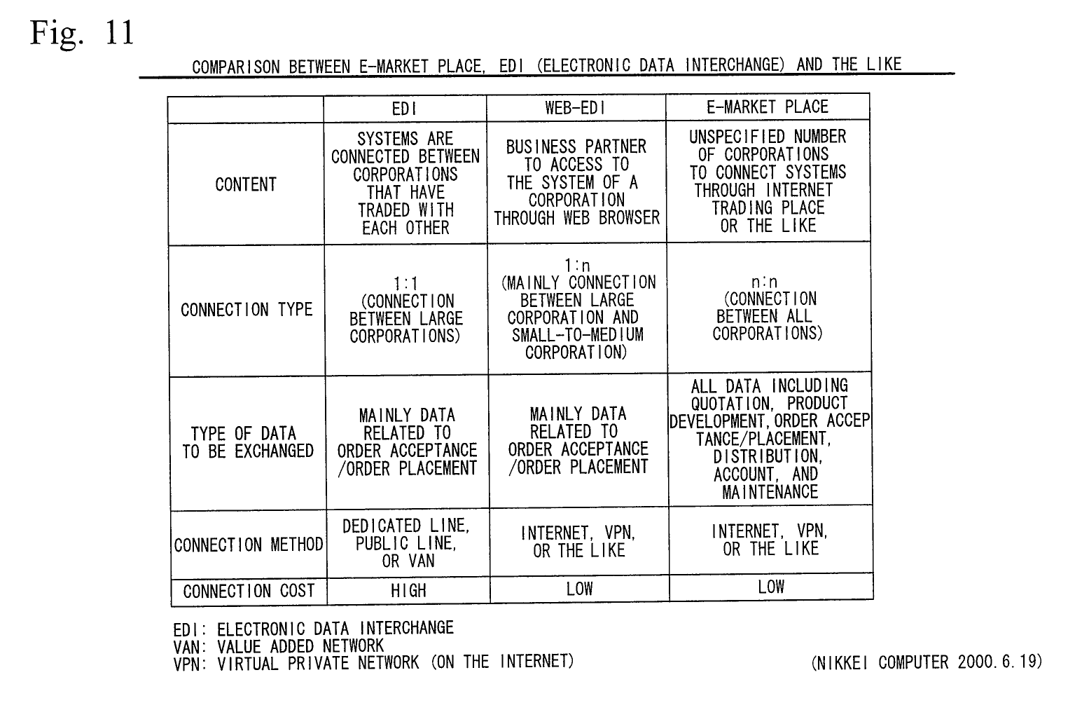

FIG. 12 is a diagram showing popularization/expansion (development patterns) of e-commerce transactions.

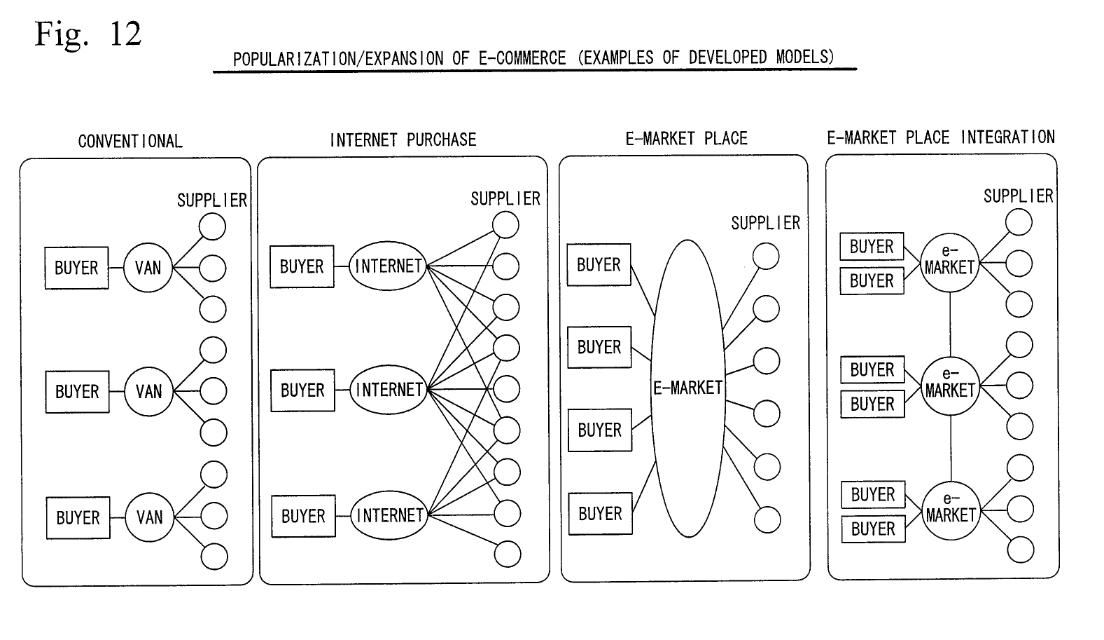

FIG. 13 is a diagram showing an example of conventional e-commerce transactions.

### BEST MODE FOR CARRYING OUT THE INVENTION

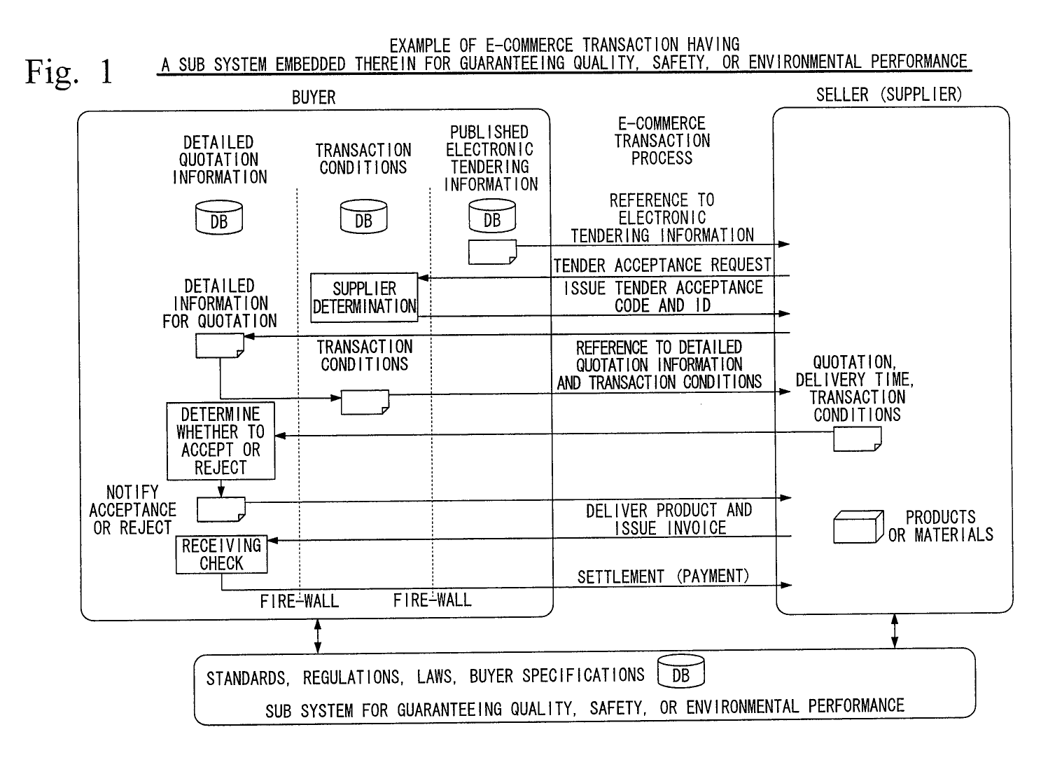

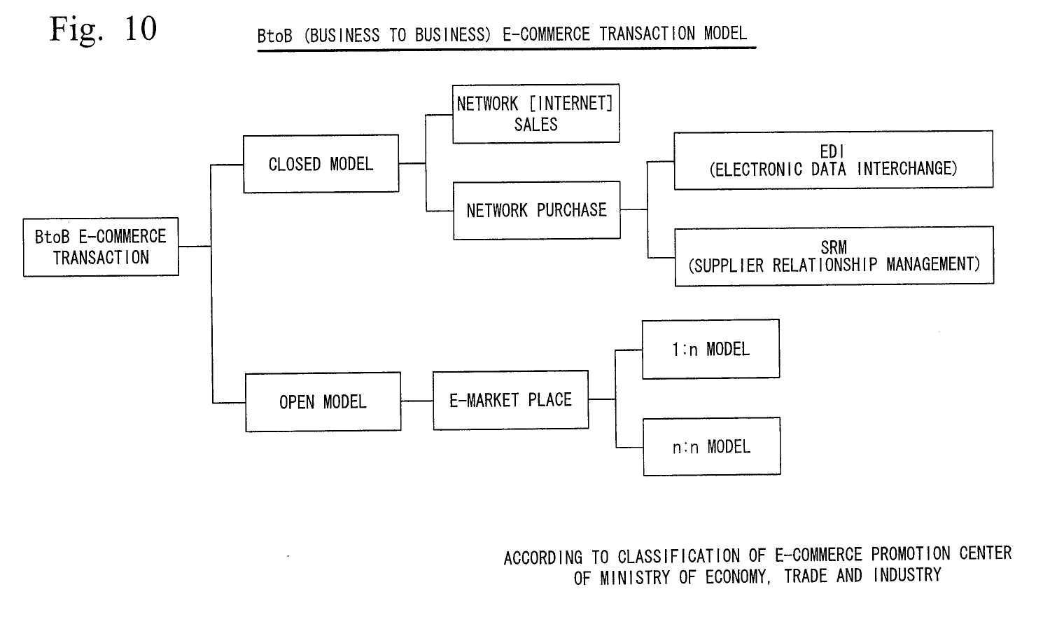

Hereunder, the present invention is described based on examples. FIG. 1 is a diagram showing an example of e-commerce transactions, in which there is embedded a subsystem for guaranteeing the quality, safety, or environmental performance of commodities. The present invention is to be operated as a subsystem of conventional e-commerce transaction on an e-commerce market place (including not only an entirely open Internet market place but also a closed network market place of a particular industry). For operating as a subsystem of an e-commerce system, obviously the present subsystem is also required to conform with electronic information processing. The present invention is based on an assumption of the entire range of B to B e-commerce transactions shown in FIG. 10. On the other hand, as for B to C (business to consumer) e-commerce transactions, when a buyer (individual consumer) makes a judgment on acceptance/rejection based on; the quality, safety, or environment related regulations, the standard, or the required specification, it is difficult for the individual to verify the correctness of the measurement values, based on which the individual makes the judgment. However, if an officially certified agent is contracted to perform the verification, then it becomes possible to apply the present invention.

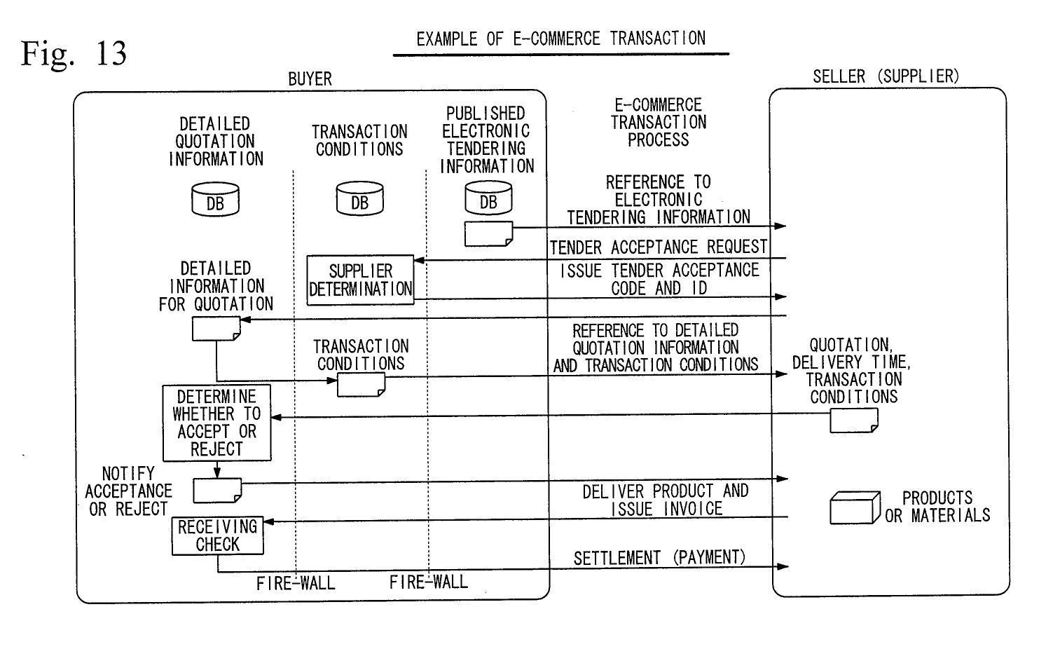

The e-commerce transaction process shown on the upper side of FIG. 1 to be carried out between the buyer and the seller (supplier) is a generic process as with the process described as a conventional technique with reference to FIG. 13. When the buyer has published electronic tendering information and received a tender acceptance request from the seller, a tender acceptance code and ID are issued. Next, the seller requests the buyer for detailed information on a quotation, and makes reference to detailed quotation information and transaction conditions. The buyer determines and notifies whether to accept or reject the quotation document, the delivery time, and the transaction conditions presented by the seller. Then the buyer delivers the products or materials, the buyer makes a payment in response to the delivery and issued invoice, and the e-commerce transaction is concluded.

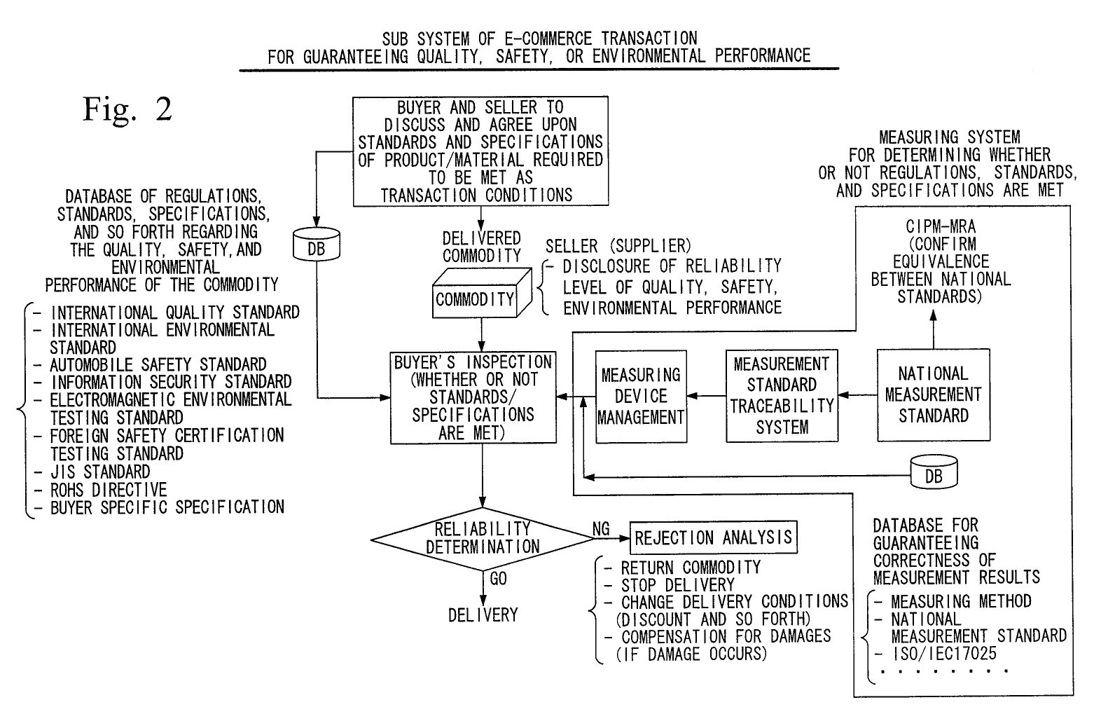

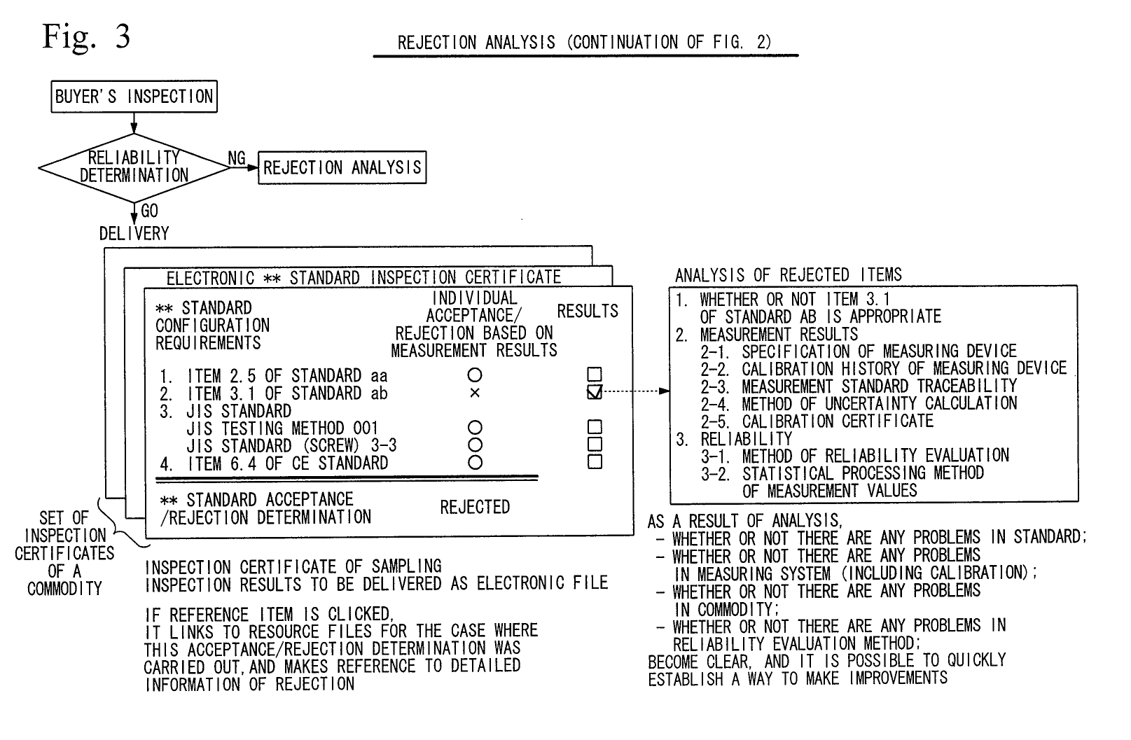

The lower side of FIG. 1 shows an example of the outline of the subsystem to be embedded in such an e-commerce transaction for guaranteeing quality, safety, or environmental performance, and the details thereof are shown as examples in FIG. 2 and FIG. 3. A database of this subsystem stores numerical characteristics that characterize the quality, safety, environment related regulations (such as laws and RoHs directive), standard (such as international standards, Japanese industrial standards, and automobile safety standards), and product specifications of commodities relevant to an e-commerce transaction being carried out, and can be viewed by both the buyer and seller.

In any of the cases where the seller unilaterally discloses these information, where the buyer unilaterally requests these information, and where there is an agreement upon discussion between the buyer and seller, the buyer, at the time of commencing the transaction or in the middle of the transaction, inspects the delivered commodity regarding these regulations, standards, and required specifications (if the quantity is large, sampling inspection is carried out) to judge acceptance/rejection (if the quantity is large, reliability judgment is made based on a statistical method), and the transaction is either continued or cancelled (or transaction conditions are changed). On the assumption that the numerical characteristics that characterize these regulations, standards, and required specifications are satisfied, the transaction is commenced and the seller delivers the commodities. At this time, the seller discloses the reliability level of the quality, safety, or environmental performance (a set level at which whether or not a large quantity of commodities satisfies these regulations and so forth is statistically determined: for example, acceptance rate 99.99%). The buyer, at the time of commencing the transaction or in the middle of the transaction, inspects the delivered commodities to determine whether or not the commodities meet the standards/specifications presented by the deliverer (if the quantity is large, a sampling inspection is carried out) to determine whether to accept or reject (if the quantity is large, a reliability determination is carried out based on a statistical method), and either continues or cancels the transaction (or changes the transaction conditions). Such determination can also be carried out even when the commodity is disassembled to components.

The buyer is responsible to guarantee the correctness of measurement values that determine whether to accept or reject the numerical characteristics characterizing these inspection items. Guaranteeing these measurement values is carried out in the “measurement system that determines whether or not regulations, standards, and specifications are met” shown in FIG. 2.

Here, FIG. 2 is described. First, the buyer and seller discuss and reach an agreement on general standards (such as JIS standard) and product specifications that the product of the e-commerce transaction object needs to meet. The details of the general standards (such as JIS standard) and product specifications that the product needs to meet are stored in a DB (database), and can be viewed by both of the parties. Prior to delivery, the seller discloses the reliability level of the quality, safety, or environmental performance of the product (a statistical acceptance rate is set on the assumption that a large quantity of the products is to be delivered). The delivery receiver carries out a sampling inspection on the product to inspect whether or not the product meets the reliability level of the standards and specifications guaranteed by the seller, and determines whether to accept or reject the product. When determining whether to accept or reject the product, values measured on a measuring device are used as criteria for determining whether or not the numerical characteristics shown in the standards/specifications are met. Therefore, the measuring device is required to be managed so as to always maintain the performance thereof. For example, it is preferable that calibration of the measuring device be carried out within a calibration cycle, and the calibration be examined by a trading organization that is audited by and registered with a certified organization affiliated with an international certification organization and that has demonstrated an ability to perform appropriate calibration on a technical examination. It is preferable that the measurement standard in the calibration have ensured traceability (traceability to national measurement standard). Regarding the national standard, it is preferable that the equivalence thereof between nations be confirmed upon international comparisons (CIPM-MRA). This is because, by linking calibration in this way, the accuracy of measurement can be guaranteed, no matter where the measurements are carried out. In the measurement management, it may be such that in a data base there is stored the latest version of the international standard ISO/IEC17025 that certifies the system of the national measuring method and the national measurement standard, the supply method, and the examination laboratory for guaranteeing the correctness of the characteristics, the calibration cycle, and the measurement results of the measuring device to be used, and it is always available to be referenced.

If the reliability level of the quality, safety, and environmental performance of the product disclosed by the seller is met, then the delivery is continued. If it is not met (if it is rejected), then the product is returned, delivery is discontinued, and delivery conditions are changed (discount according to actual reliability level to be made), and if damage has been made, then business actions such as damage compensation may need to be taken. Moreover, in the case of rejection, the reason for the rejection can be analyzed in detail for future improvements if the seller wishes. That is to say, in the case where the inspection certificate has been submitted as an electronic file, the following items are traced back and verified: identification of the section and the standard thereof that forms a certain standard at which the rejection occurred; identification of the measuring device that measured the numerical characteristics of this standard; whether or not the management of this measuring device has been appropriately carried out; identification of the operator who carried out calibration for this measuring device; whether or not the measurement standard traceability is appropriate; and whether or not the method of calculating uncertainty is correct, to clarify: whether or not there is any problem in the standard and it has caused the rejection; whether or not there is any problem in the measuring system including calibration; whether or not there is any problem in the reliability evaluation method; and whether or not there is any defect in the product itself. As a result, a way of making improvements can be quickly attained.

Responsibility for guaranteeing correctness of measurement values that determine acceptance/rejection includes: ensuring that measuring device management (for example, calibration to be carried out within the calibration cycle of the measuring device; measurement values acquired on a measuring device with expired calibration cycle must not be used for determining acceptance/rejection) and calibration trace complies with a reliable measurement standard traceability system (for example, JCSS [Japan calibration service system); and ensuring to clarify the reliability evaluation method used to calculate the reliability level. The buyer is required to check the measuring device for guaranteeing correctness of the measurement values for determining whether to accept or reject the numerical characteristics that characterize these items prior to inspection, and to manage the measuring device so that appropriate measurement values can be acquired. For example, the measuring instruments must be repaired if it is not operating correctly; if the calibration cycle has expired, the measuring instruments need to be pre-calibrated; and the measurement environment (including temperature, humidity, vibration, and electromagnetic noise) needs to be maintained at an appropriate level.

These regulations, standards, required specifications, and so forth are usually formed with requirements having a hierarchical structure. Therefore, regarding the commodity, the buyer determines whether to accept or reject the reliability of the numerical characteristics that characterize these individual requirements. Or, since the commodity is usually formed with many components, the buyer determines whether to accept or reject the numerical characteristics that characterize the regulations, standards, required specifications and so forth of each of these components. Moreover, when handling a large quantity, instead of performing individual determination, a statistical reliability evaluation method may be used for determination.

FIG. 3 is a diagram showing an example of detailed analysis of acceptance/rejection. The buyer sends a certificate of the inspection result as an electronic file to the seller. This inspection certificate shows not only comprehensive determination results but also individual determination results regarding the numerical characteristics that characterize the requirements that form the regulations, standards, specifications and so forth regarding the commodity.

In the case where an item is rejected and the seller has a doubt about the determination result, if the reference item is invoked, it can be linked to detailed rejection information (whether or not the version of the regulations and so forth is appropriate; the measurement results; the management status of the measuring device; the calibration history of the measuring device; the measurement standard traceability; the reliability evaluation method and the statistical processing method used to calculate the reliability level; and so forth). By analyzing the rejection items, it is possible to clarify: whether or not there is any problem in the standard (for example, the buyer and seller respectively made reference to different versions of the same standard), or whether or not there is any problem in the measuring system (management and calibration of the measuring device, and measurement standard traceability for calibration), uncertainty calculations, or the reliability evaluation method, and a way of making improvement can be quickly attained as a result.

Furthermore, if an item is rejected, how it is distributed with respect to the target numerical characteristic is analyzed, and it is reported to the person who requested measurement whether or not the acceptance and cost are balanced (even if accepted, whether or not it is distributed in the proximity of the target value and an excessive quality has caused cost overrun).

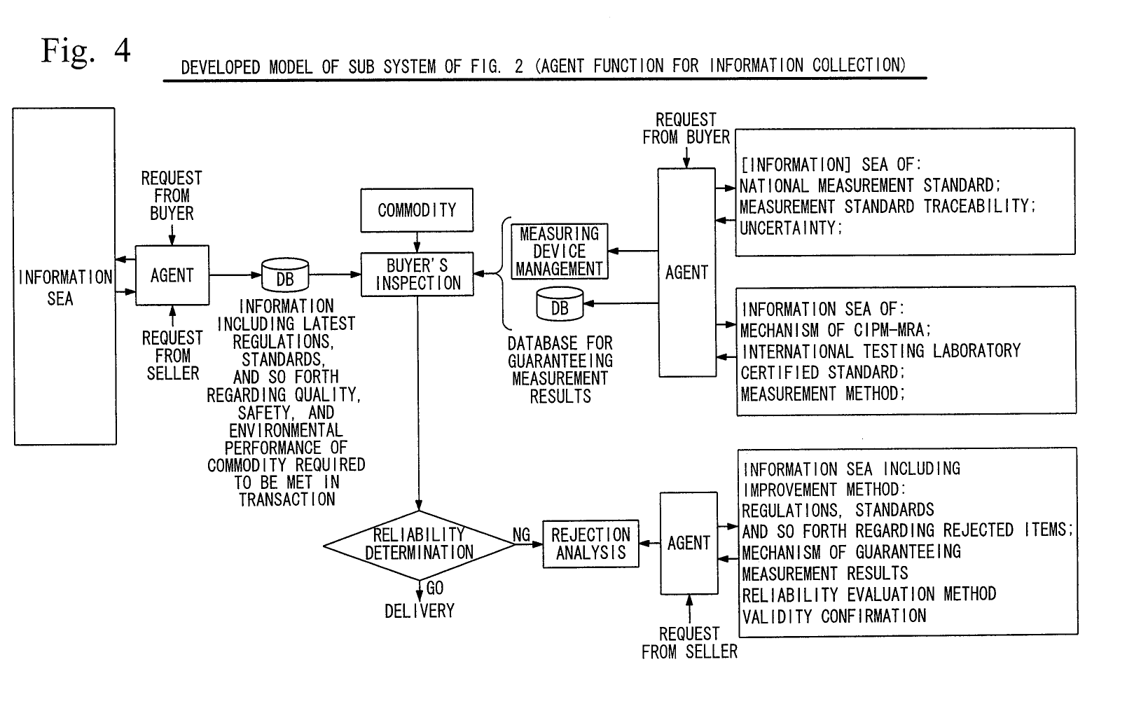

FIG. 4 is a diagram showing an example of an agent function of information collection that corresponds to the developed type of the subsystem of FIG. 2. In the series of procedures, there may be provided a dedicated agent function for quickly collecting required information from a large volume of information. For example, this includes: an agent function that appropriately selects the regulations, the standards, the required specifications and so forth regarding the quality, safety, or environmental performance that need to be met for the target commodity for the buyer and seller in an e-commerce transaction; an agent function that appropriately selects the measuring device management, the measurement standard traceability (traceability), the reliability evaluation method used to calculate the reliability level, and so forth for guaranteeing the measurement results that need to be shown in the inspection by the buyer; an agent function that summarizes the detailed contents of the item rejected as a result of the inspection; and a competent and equitable agent function that also carries out an inspection for determining whether to accept or reject.

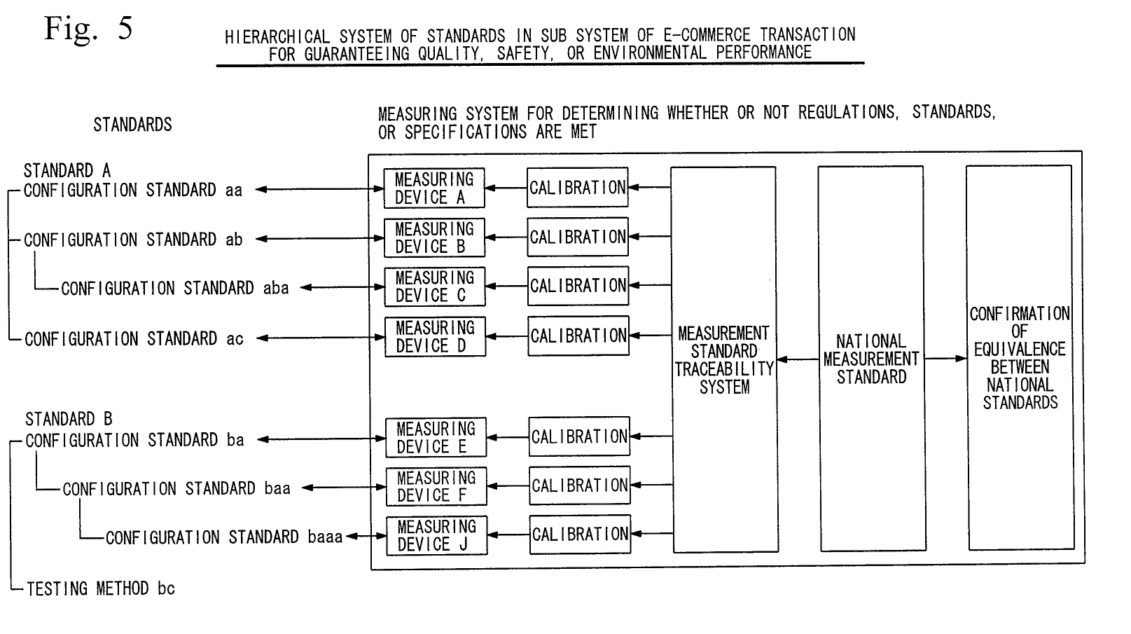

FIG. 5 is a diagram showing an example of a hierarchical system of standards in the subsystem of e-commerce for guaranteeing quality, safety, or environmental performance (supplemental description for FIG. 2). The regulations, standards, required specifications and so forth regarding the quality, safety, or environmental performance that a target commodity of an e-commerce transaction needs to meet are broken down into component requirements, and the buyer carries out inspection on respective items to determine acceptance or rejection. The buyer is responsible for guaranteeing the correctness of measurement values that determine acceptance or rejection of the respective items. For example, where a commodity meets a standard A and standard B regarding quality, safety or environmental performance, these standards comprise hierarchically formed standards, and respectively form a pair with a measuring device and measurement standard traceability system for determining whether or not these standards are met.

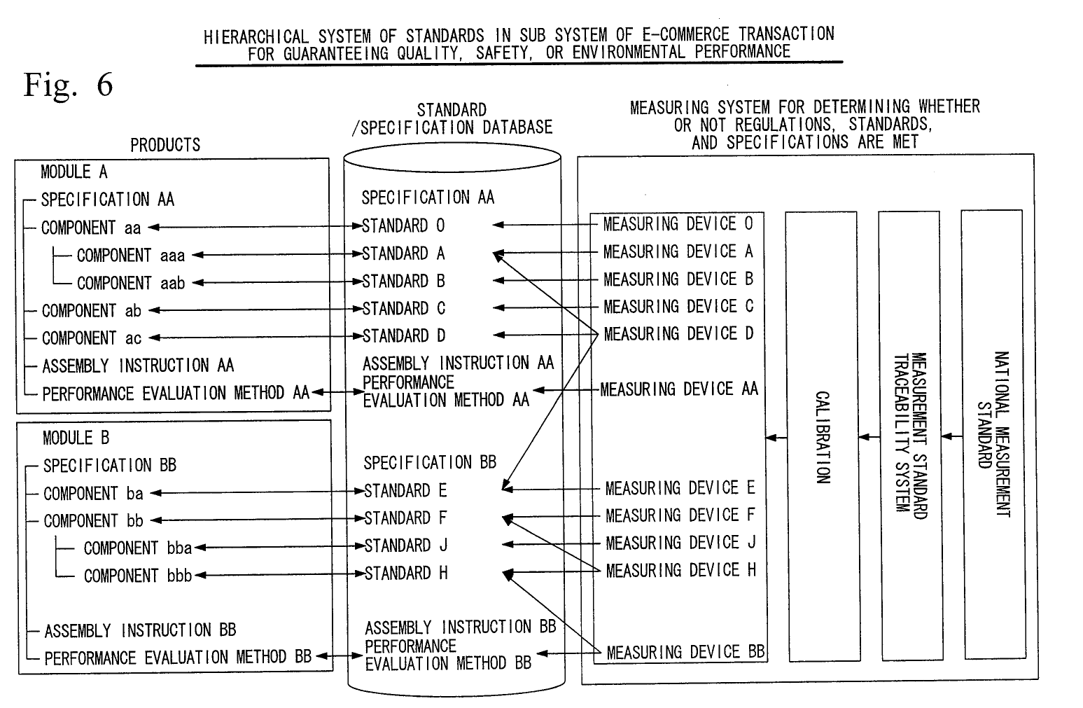

FIG. 6 is a diagram showing an example of a hierarchical system of a commodity in the subsystem of e-commerce for guaranteeing quality, safety, or environmental performance (supplemental description for FIG. 2). A target commodity for the e-commerce transaction is disassembled into component parts (or module components), and the buyer carries out inspection on each item of the regulations, standards, required specifications and so forth regarding the quality, safety or environmental performance that these component parts need to meet to determine whether to accept or reject the commodity. The buyer is responsible for guaranteeing the correctness of measurement values that determine acceptance or rejection of the respective items. For example, where a product comprises component modules A and B and parts that form these modules, the measuring device and the measurement standard traceability system thereof for determining whether or not the standards and specifications that these component parts need to meet, form a pair.

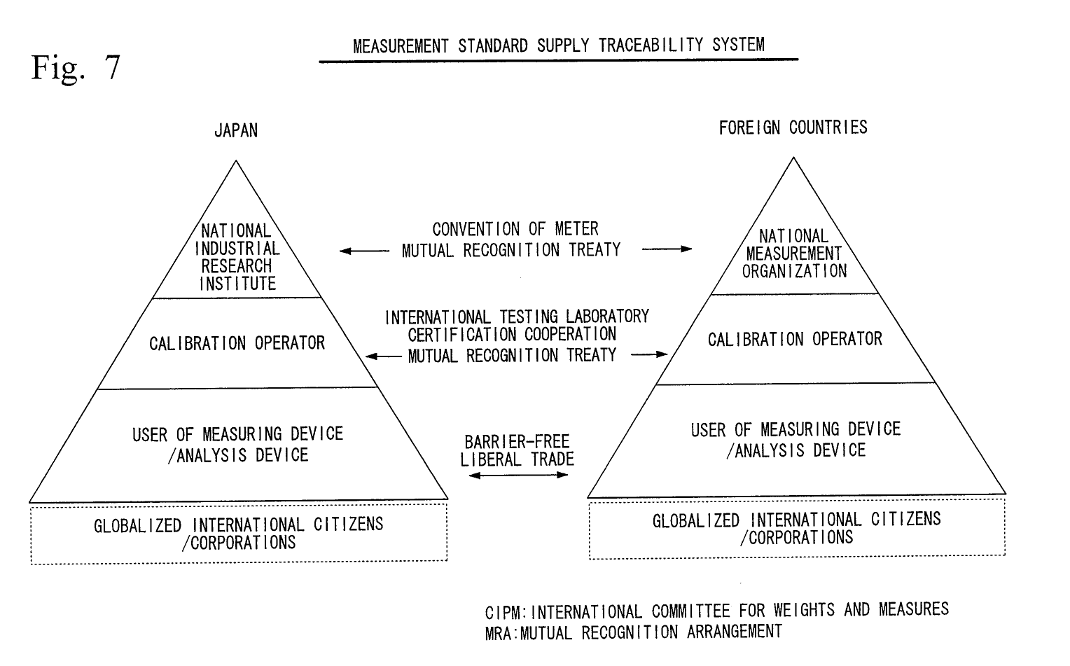

FIG. 7 is a diagram showing an example of a measurement standard supply traceability system (supplemental description of FIG. 2). The system shown as an example is an international measurement standard supply traceability system according to the framework of CIPM-MRA (International committee for weights and measures—mutual recognition arrangement). With regard to the measurement standard traceability (traceability), in order to ensure a constant quality in international e-commerce transactions, it is preferable that the following requirements be met:

a) the national measurement standard organization participates in CIPM-MRA (international committee for weights and measures—mutual recognition arrangement) advocated by the bureau international des poids et measures (BIPM);
b) the measurement organization is certified in accordance with the international laboratory accreditation standard (ISO/IEC17025) for ensuring quality of measurement standard supply; and
c) requirements of an appropriate standard supply system (for example, JCSS (Japanese calibration service system) or ASNITE-CAL) should be satisfied.
Measurement values acquired on a measuring device calibrated on such a measurement standard system are expected to be compatible anywhere in the world. This is appropriate for guaranteeing the quality, safety, or environmental performance in global e-commerce transactions.

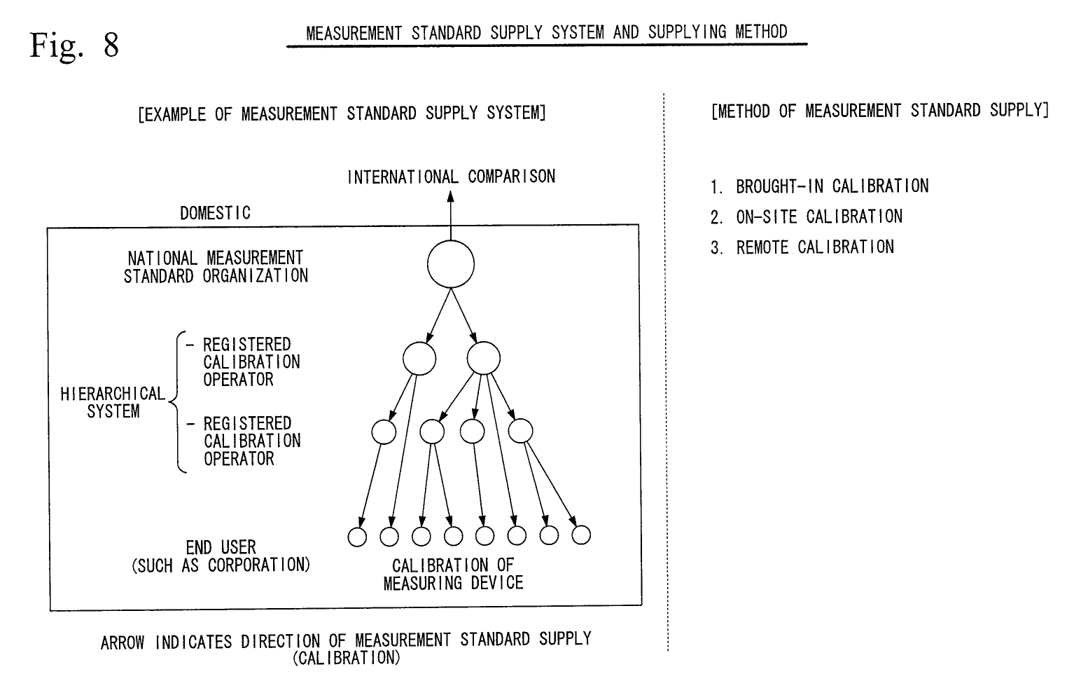

FIG. 8 is a diagram for describing a measurement standard supply system and a measurement standard supply method (supplemental description of FIG. 7). The standard supply of the measurement standard for guaranteeing measurement results that need to be shown by the buyer in the inspection is based on an appropriate measurement standard supply system (for example, JCSS [Japan calibration service system] and ASNITE-CAL). The measurement standard supply method includes carry-in calibration, visiting calibration, and remote calibration. The carry-in calibration is such that calibration equipment are carried in to an upper standard organization to carry out calibration. The visiting calibration is such that in the case where it is difficult to transport calibration equipment, an operator from the superior organization visits the site where the calibration equipment are present to carry out calibration. The remote calibration is such that without an operator from the upper organization having to visit the site and without having to transport the calibration equipment, with use of communication technologies, calibration is carried out on site at the responsibility of the calibration organization. The remote calibration offers an excellent level of consistency for an entirely computerized e-commerce transaction system.

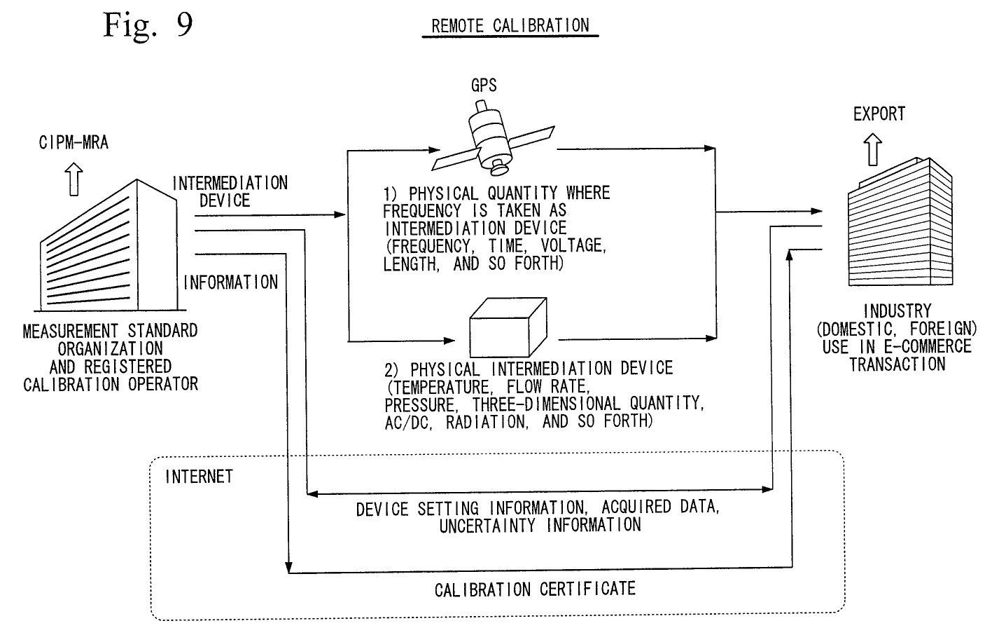

FIG. 9 is a diagram for describing the remote calibration (supplemental description of FIG. 8). The remote calibration (refer to Japanese Patent Application No. 2005-281152 “Remote calibration and system”), in an e-commerce transaction where Internet technologies are heavily used, offers a high level of consistency of remote calibration in which the latest communication technologies (such as GPS and optical communication) and information technologies are actively used. With use of the latest information communication technologies (such as Internet, optical communication, and GPS), standard supply, which is the starting point for quality assurance, can be carried out quickly, inexpensively, and accurately.

1. An e-commerce system whereby a buyer buys commodities sold by a seller through an e-commerce market place, wherein:
there is embedded a subsystem that guarantees quality, safety, or environmental performance of the commodities;
the subsystem is provided with a database that stores numerical characteristics that characterize regulations, standards, or required specifications regarding the quality, safety, or environmental performance of the commodities to be traded in the e-commerce transaction, and the database can be viewed from both the buyer and seller;
to the buyer, the seller delivers the commodity, the quality, safety, or environmental performance of which are guaranteed regarding the numerical characteristics that characterize said regulations, standards, or required specifications; and
the buyer, when carrying out inspection on the delivered commodity to see whether or not the regulations, standards, or required specifications are met to determine whether to accept or reject the commodity, guarantees correctness of measurement values for determining acceptance/rejection upon the numerical characteristics that characterize the regulations, standards, or required specifications.

2. An e-commerce system according to claim 1, wherein for guaranteeing of the quality, safety, or environmental performance of the commodities, the seller discloses: measurement results for certifying that numerical characteristics that characterize the regulations, standards, and required specifications related to the commodities are met; traceability to measurement standards for certifying correctness of the measurement results; a reliability evaluation method; or the reliability level thereof.

3. An e-commerce system according to claim 2, wherein in order to request the seller for said guaranteeing of the quality, safety, or environmental performance of the commodities, the buyer discloses regulations, standards, or required specifications related to the quality, safety, or environmental performance of the commodity that the buyer wishes to purchase.

4. An e-commerce system according to claim 2, wherein in order to request the seller for said guaranteeing of the quality, safety, or environmental performance of the commodities, the buyer and the seller discuss regulations, standards, or required specifications that concern the quality, safety, or environmental performance that need to be met for the target commodity of the e-commerce transaction, and reach an agreement on which one of them to be employed and operated.

5. An e-commerce system according to claim 1, wherein the regulations, standards, and required specifications related to the quality, safety, or environmental performance that the target commodity of the e-commerce transaction needs to meet are broken down into component requirements, and the buyer carries out inspections on respective items to determine acceptance or rejection, while the buyer guarantees correctness of measurement values that determine acceptance or rejection of the respective broken-down items.

6. An e-commerce system according to claim 1, wherein the commodity is disassembled into component parts or module components, and the buyer carries out an inspection on each item of the regulations, standards, and required specifications regarding the quality, safety or environmental performance that these component parts or module components need to meet, to determine whether to accept or reject, while the buyer guarantees correctness of measurement values that determine acceptance or rejection of the respective disassembled items.

7. An e-commerce system according to claim 1, wherein an inspection certification of the result of the inspection and acceptance/rejection determination by the buyer is sent as an electronic file from the buyer to the seller, and the inspection certificate shows not only comprehensive determination results but also an individual determination result of each of the requirements that form the regulations, standards, and specifications regarding the commodity.

8. An e-commerce system according to claim 7, wherein in the case where any of the individual determination results of said requirements is rejected, by invoking related reference items, a link to the detailed rejection information can be established.

9. An e-commerce system according to claim 7, wherein there is provided a function that, in the case where individual determinations results of said requirements are accepted, analyzes their distributions with respect to the target numerical characteristics, and that reports whether or not the acceptance and cost are balanced to the person who requested the measurements.

10. An e-commerce system according to claim 1, wherein there are provided: an agent function that appropriately selects regulations, standards, and required specifications regarding the quality, safety, or environmental performance that need to be met for the target commodity for the buyer and seller in an e-commerce transaction; an agent function that appropriately selects measuring device management, measurement standard traceability, or reliability evaluation method used to calculate reliability level, for guaranteeing measurement results that need to be shown in the inspection by the buyer; an agent function that summarizes the detailed contents of the item rejected as a result of the inspection; or an agent function to which the inspection for determining acceptance or rejection is entrusted.

11. An e-commerce system according to claim 2, wherein the traceability of said measurement standard is based on the measurement standard supply program in which a national measurement standard organization participates in the international committee for weights and measures—mutual recognition arrangement for ensuring constant quality even in international e-commerce transactions.

12. An e-commerce system according to claim 11, wherein said measurement standard supply organization is an organization approved based on the international laboratory accreditation standard (ISO/IEC17025) for ensuring the quality of the measurement standard supply.

13. An e-commerce system according to claim 12, wherein supply of said measurement standard is carried out based on a measurement standard supply system.

14. An e-commerce system according to claim 12, wherein said measurement standard is supplied by any one of carry-in calibration, visit calibration, and remote calibration.

15. An e-commerce method whereby a buyer makes a purchase of commodities sold by a seller through an e-commerce market place, wherein:
a database stores numerical characteristics that characterize regulations, standards, or required specifications regarding the quality, safety, environmental performance of the commodities in the e-commerce transaction, and the database can be viewed from both the buyer and seller;
to the buyer, the seller delivers the commodities, the quality, safety, or environmental performance of which are guaranteed regarding the numerical characteristics that characterize said regulations, standards, or required specifications; and
the buyer, when carrying out inspection on the delivered commodities to see whether or not the regulations, standards, or required specifications are met to determine whether to accept or reject, guarantees correctness of measurement values for determining acceptance/rejection upon the numerical characteristics that characterize the regulations, standards, or required specifications.
